(19) United States
(12) Patent Application Publication
(10) Pub. No.: US 2025/0155232 A1
(43) Pub. Date: May 15, 2025

(54) METHOD FOR CHECK MEASUREMENT OF A LOG PROCESSED WITH TREE-HANDLING DEVICE, CORRESPONDING MEASUREMENT SYSTEM, FOREST MACHINE AND HARDWARE

(71) Applicant: PONSSE OYJ, Vieremä (FI)

(72) Inventors: Esko Havimäki, Vieremä (FI); Antti Uurtamo, Rovaniemi (FI)

(21) Appl. No.: 18/839,971

(22) PCT Filed: Feb. 24, 2023
(86) PCT No.: PCT/FI2023/050108

§ 371 Date: Aug. 20, 2024

(30) Foreign Application Priority Data
Feb. 25, 2022 (FI) 20225177

(51) Int. Cl. G01B 5/00; G01B 5/02; G01B 5/08; G01B 21/04

(52) U.S. Cl. CPC G01B 5/0035; G01B 5/025; G01B 5/08; G01B 21/042

(57) ABSTRACT

The invention relates to a method for a check measurement of a log processed with a tree-handling device. In the method, a diameter of the log is measured with a measurement device according to a measuring instruction created for the log and determined based on measurement data created in connection with a processing of the log with the tree-handling device. A diameter measured with the measurement device is compared to the diameter determined in connection with the processing of the log with the tree-handling device. Based on the comparison, an accuracy of the diameter determined in connection with the processing of the log with the tree-handling device is determined. A diameter determination in connection with the processing of the log is controlled and/or information concerning the performed diameter determination is created based on the determined measuring accuracy.

### CROSS-REFERENCE TO RELATED APPLICATIONS

This application claims benefit of PCT/FI2023/050108 filed Feb. 24, 2023, which claims benefit of Finnish Patent Application No. FI 20225177 filed Feb. 25, 2022, each of which is incorporated by reference in its entirety.

### FIELD OF THE INVENTION

The invention relates to a method for a check measurement of a log processed with a tree-handling device. In addition, the invention relates also to a corresponding measurement system, a forest machine and hardware.

### BACKGROUND OF THE INVENTION

Logging is performed with a multi-process machine equipped with a harvester head in accordance with the cut-to-length (CTL) method. The harvester head is used there to simultaneously fell, delimb and cut a tree into cut-to-length logs. While running a tree through the harvester head, the diameter of the tree is also simultaneously measured at an established accuracy in the lengthwise position of the tree and thus the log prepared from it. In this way, it is possible to know the volume of the tree and thereby also the logs prepared from it. Based on the measurement, the seller is paid for the trees cut.

The diameter of a tree is measured with sensors, for example. Sensors can be arranged, for example, in rotatable delimbing knives and/or rotatable feeding rollers or rolls of the harvester head. The length and thus also the lengthwise position of the diameter measurement can be measured with a measuring wheel, for example. For this, it is provided with sensors. All of these run along the surface of the tree when feeding the tree through the harvester. Based on these, it is possible to know the diameter of the tree at each longitudinal measuring point of the tree and the volume computed based on these.

According to the current practice, check measurements must be performed every now and then to monitor the accuracy of the measuring operation carried out by the harvester head and possibly also correct it. If it is discovered based on the check measurement that the measurement is not correct, the measurement arrangement of the harvester head must be tuned. This, too, is performed based on the check measurement. The automation system of a multi-process machine may indicate when a check measurement is due. A typical check measurement is a random measurement. There are different rules for imposing it. A check measurement is performed in accordance with a preset instruction. It can vary by country, for example. Most typically, however, several logs for different diameter classes are prepared with a harvester head for a check measurement. Log diameters and corresponding lengthwise positions are stored. After preparing the logs, a manual check measurement is performed. This takes place, for example, with a caliper as a so-called crosswise measurement. The measurement is thus performed by a forest machine driver, for example.

With a caliper, the check measurement is taken at preset and thus fixed longitudinal measuring points along the log. In Finland, for example, it is instructed to measure the diameter of each log at certain standard measuring points counting from the end of the log, in the longitudinal direction of the log. It is instructed to measure the last diameter of the log in the middle of the last log section. In addition, standard measuring points can be different, for example, between a butt log and other logs.

A crosswise measurement means, in turn, that the diameter of the log is measured at the same measuring point from two directions. The difference between these directions is most preferably 90 degrees. The purpose of this is to compensate for possible ellipticity of the tree, for example. Log diameters at each measuring point are stored, for example, in a caliper in connection with the measurement. Log diameters are transferred to, for example, multi-process machine for a comparison with the measurements that it has taken on corresponding logs.

However, many inaccuracy factors are associated with measurements performed with a caliper. These are both due to logs or measuring conditions and human factors. A first one of these includes branch knots, protuberances, enlargements, ellipticity, curvature and other similar deformations in logs. For example, a log may have multiple branch knots in its longitudinal direction in annual growth branch whorls, for instance. When such a branch knot is located at a fixed standard measuring point of the log, at which the log diameter is to be measured according to the Timber Measurement Act or Regulation, the measurement will very likely include measurement errors or at least deviations between different measurers. Particularly for an inexperienced caliper measurer, it is difficult to detect the above-mentioned from a delimbed tree, from which the bark has often detached at least partly. Thus, the measurement result can be highly dependent on the measurer. Most typically and despite careful measuring work, the error is smaller for an experienced measurer than for an inexperienced one.

In addition to the above, a crosswise measurement of a log taken at each measuring point using a 90 degrees angle as instructed is far from always possible. It can be restricted, for example, by the terrain in which the log has been prepared (for example, hummocks when touching the imposed measuring position) and also by snow in winter. In this case, the caliper cannot by rotated for the required 90 degrees, for example, but the crosswise measurement must be performed using a smaller angle of rotation. And even though the caliper could be rotated sufficiently for a crosswise measurement, there may be a one-sided branch knot on that side of the log that is not visible to the measurer or bent over bark between the measuring insert of the caliper and the log. This distorts the measurement result. The measurement result can additionally be affected by the shape of the log prepared. For example, when preparing a log on a bed timber, it turns on its wide side when falling down to the ground from the harvester head grasp. This, too, has an effect on the measurement accuracy of the caliper measurement. Although there are various rules and guidelines for measuring aiming to eliminate the afore-mentioned factors, a human factor is still always associated with a caliper measurement causing differences in the measurement result. An example of this is the clamping force used by the measurer when pressing the measuring inserts of the caliper against the surface of the log.

It may be demanding for a forest machine driver to select the measuring points and detect the afore-mentioned deviations from the logs. In addition, measurement results may vary greatly between different drivers. Because of this, caliper measuring differences, i.e., divergence between different measurers can be as much as between 5% and 6% by volume. The differences between experienced and well-informed measurers can be of the order of 2%.

From a self-monitoring measurement of a multi-process machine used, for example, in Finland it follows that for drivers, who perform caliper measurements, a reference measurement is not available, if they do not measure a check measurement batch of 30 logs to be performed twice a year at the same time while an external measurer does this. This leads to that, for young drivers and drivers starting their career, for example, it is very challenging to learn to measure logs in the right way taking into account their branch knots and ellipticity, etc. In turn, as a consequence of this, the tuning of the diameter measurement of a tree-handling device may be incorrect. In this case, there may be big measuring differences between drivers who work in different shifts with the same multi-process machine, and the diameter measurement of the multi-process machine is constantly adjusted.

### SUMMARY OF THE INVENTION

The present invention is generally directed to forest machinery and, more particularly, to a system and methods for a check measurement of a log processed with a tree-handling device for improving the measuring accuracy of the check measurement.

In one aspect, the diameter of at least one log processed with a tree-handling device is measured with a measurement device according to a measuring instruction. The measuring instruction is determined based on measurement data created in connection with the processing of the log with the tree-handling device. Thus, it is not necessarily instructed to measure each log prepared for a check measurement according to the same formula, but there is a dedicated measuring instruction for at least part of logs. This measuring instruction is based at least partly on the measurement data created in connection with the processing, such as, for example, the preparation of the log with a tree-handling device. Thus, owing to the invention, it is possible to consider error factors appearing in logs, which are exactly defined based on the measurement data created in connection with the processing performed with a tree-handling device and which affect the check measurement performed with a measurement device, and/or to also eliminate human measurement errors related to the measurement.

Thus, it can also be stated that, in the method and measurement system according to the invention, it is instructed to use adaptive measuring points as part of log-specific measuring instructions, determined based on the measurement data created in connection with the processing of the log with a tree-handling device. Adaptive measuring points can be used exclusively or together with standard measuring points of the type that are used as prior art and in context with the current guidelines for a check measurement, for example.

In another aspect, with more reliable adaptive measuring points according to the invention, it is also possible to filter out unreliable measuring points from possible standard measuring points and/or reduce their weighting, for example.

Advantageously, when using the measurement data created in connection with the processing performed with a tree-handling device in accordance with the method, tuning of the diameter measurement of a work machine and/or a tree-handling device can be made much more reliable than with mere prior art standard measuring points.

As another advantage of the present disclosure, tuning of the diameter measurement of a work machine and/or a tree-handling device becomes possible for lower-quality trunks, as well. Further, it is possible to determine, based on the measurement data, measuring points that are reliably measurable with a measurement device and in connection with the processing performed with a tree-handling device for lower-quality trunks, as well. With the method and the measurement system according to the present disclosure, actions related to the determination of accuracy of the diameter measurement of a work machine and/or a tree-handling device, such as, for example, measurement tuning, monitoring of measuring accuracy and reporting based on it are based on substantially more reliable measurement data than in procedures according to known practices. Additional advantages are listed in the description portion.

While the invention is susceptible to various modifications and alternative forms, specific exemplary embodiments thereof have been shown by way of example in the drawings and have herein been described in detail. It should be understood, however, that there is no intent to limit the invention to the particular embodiments disclosed, but on the contrary, the intention is to cover all modifications, equivalents, and alternatives falling within the scope of the invention as defined by the appended claims.

### BRIEF DESCRIPTION OF THE DRAWINGS

The invention, which is not restricted to the embodiments presented below, is described below in more detail by making reference to the enclosed drawings, in which:

FIG. 1 is a simplified basic view of an example of a work machine, now a forest machine, and a measurement device, being now a caliper, in the context of which the invention can be applied;

FIG. 2 shows an example of a tree-handling device, being now a harvester head, in the context of which the invention can be applied;

FIG. 3 is a diagram illustrating the operating environment related to the method and the measurement system;

FIG. 4 shows an embodiment according to the method in a flow chart while preparing logs with a tree-handling device for a check measurement;

FIG. 5 shows an example of measurement data and a measuring instruction created based on it for logs to be prepared from a tree;

FIG. 6 shows an embodiment according to the method in a flow chart while performing a check measurement with a measurement device;

FIG. 7a shows an example of one log, measurement data created from it in connection with the processing performed with a tree-handling device and a measuring instruction created from it;

FIG. 7b shows an example of measurement data in the case of FIG. 7a, where the measurement data comprises raw data and filtered data;

FIG. 8 shows an embodiment according to the method in a flow chart for processing and using measurement results obtained with a measurement device;

FIG. 9a illustrates an exemplary embodiment for determining ellipticity of a log with a measurement device; and

FIG. 9b further illustrates the embodiment of FIG. 9a for determining ellipticity of a log with a measurement device.

### DETAILED DESCRIPTION OF THE DRAWINGS

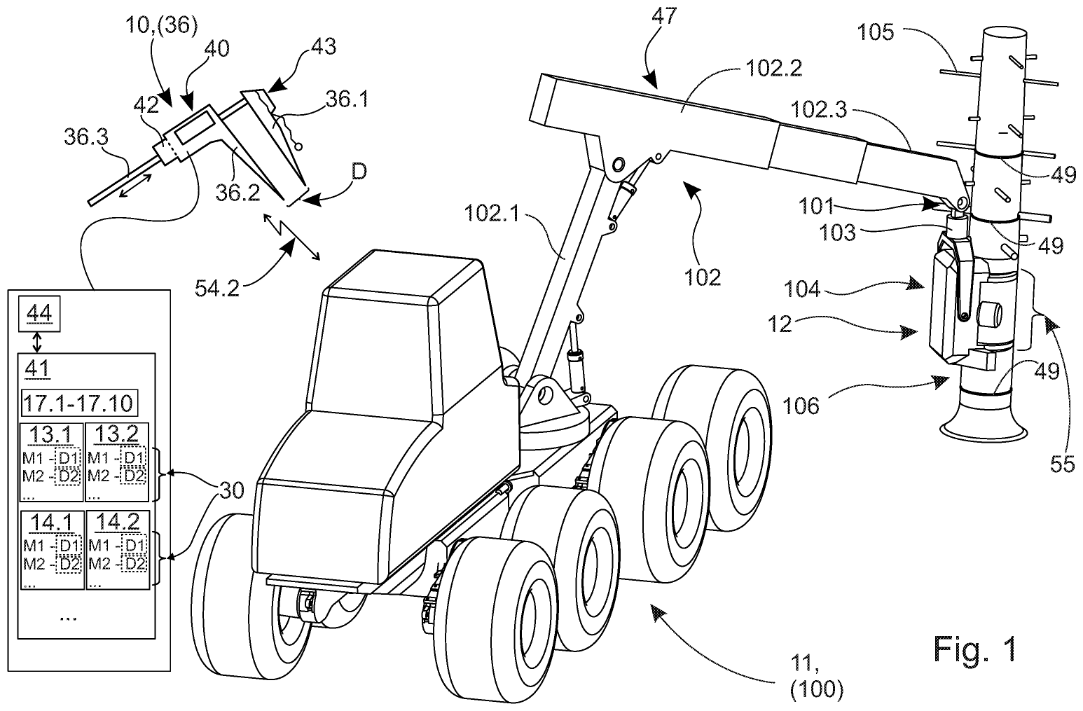

FIG. 1 shows a simplified basic drawing of one example of a work machine 11 and a measurement device 10, in the context of which the invention, more specifically, the method and the measurement system 51 can be applied. The work machine 11 is here a forest machine 100 and the measurement device 10 is now a caliper 36. Shown here as the forest machine 100, is a multiprocess machine, which is also commonly referred to as a harvester. With this kind of machine configuration, the tree 106 to be cut is first felled and, immediately thereafter, the tree 106 felled can be delimbed removing branches 105 and cut to logs according to the cut-to-length method (CTL harvesting). In the described embodiment, the tree-handling device 12 is a harvester head 104 shown in FIGS. 1 to 3. It is either hung or otherwise connected to a boom assembly 102 of a work machine 11 or now the forest machine 100, functioning as a crane 47. Henceforth, when describing the embodiments of the invention, the harvester head 104 is used as an example of a tree-handling device 12. However, it is obvious to those skilled in the art that instead of a harvester head 104, the tree-handling device 12 can just as well be any tool that enables, in connection with the processing performed with it, a measurement of the lengthwise position m1-mn of a tree 106 or a log and the corresponding diameter d1-dn measured from it in connection with the diameter and length measurement. Thus, the tree 106 or a log prepared from it, with or without branches 105, for example, is fed through a tool, that is, a tree-handling device 12. Hence, the tree-handling device 12 may be, for example, a cutting device, which prepares logs from the tree 106 or cuts its top, or a delimber/debarker, which delimbs either the tree 106 or the logs prepared from it removing branches 105, or a combination of these, without the felling/cutting function, which is typical for a harvester head 104, for example. However, it is characteristic of a tree-handling device 12 and/or a work machine 11 that operates it that, in connection with the processing performed with it, the diameter d1-dn of a tree 106 or a log tied to the measuring position m1-mn is measured. The measuring accuracy of this measurement must be monitored, the measurement must be tuned, checked and/or reported using, for example, a measurement external to the work machine 11 and/or the tree-handling device 12. This measurement takes place after the processing of a tree 106 or a log performed with the tree-handling device 12 or after log preparation, which includes a diameter measurement. Therefore, more generally, it is possible to refer to processing of a tree and/or a log with a work machine 11 and/or tree-handling device 12, where measurement data 28 is created in connection with this processing from the tree and/or the log independent of its creation method or means. In addition to the cut-to-length (CTL) method, which is used in this application as an application example of the method, the method according to the invention is also just as well suitable for the tree-length method, for example. According to an embodiment, this method can also be carried out with a harvester head 104, for example. There, each step may have a machine and/or tree-handling device of its own but, just as well, steps can be combined to be performed with the same machine and tree-handling device. For example, according to an embodiment, in the tree-length method, it is possible to fell the tree 106 with one device and then run the tree 106 through the tree-handling device 12 in a separate independent process, in connection with which it is measured with either feeding rollers and/or delimbing knives, for instance. Finally, the top of the tree 106 can be cut off. Thus, in the context of the invention, the term ^{y}log′ can also be understood, instead of a cut-to-length log of the cut-to-length method, as a tree stem according to the tree-length method, which may have been delimbed, debarked and from which only the top has been cut off.

A forest machine 100 also includes a crane 47 in a manner known per se. The crane 47 can be composed of a boom assembly 102 in a manner known per se. The boom assembly 102 can be composed of at least two booms articulated to each other; that is, a construction composed of a main boom 102.1 and a knuckle boom 102.2 that is pivotally articulated to the frame of the forest machine 100. A tree-handling device 12 is connected to the end 101 of the outermost boom 102.2 of the boom assembly 102. The tree-handling device 12 is now in this case a harvester head 104 including actuators, control equipment and determination means for felling, delimbing and cutting trees 106 into cut-to-length logs. The knuckle boom 102.2 of the boom assembly 102 may now comprise an extendable extension 102.3, a so-called telescopic extension, to increase the extension of the boom assembly 102. The forest machine 100 can be equipped with wheels or a crawler chassis, for example.

In the context of the invention, it is also obvious to those skilled in the art that, in addition to a forest machine 100, the method and a corresponding measurement system 51 according to the invention are just as well suitable for use, for example, with excavators and other work machines equipped with a work boom assembly that can be used to operate a tree-handling device 12. Likewise, a work machine 11 is not even necessary as regards the method or the measurement system 51. For example, the treelength method does not necessarily have a special work machine at all for a tree-handling device, but the tree-handling device, such as, for example, a delimber, is an independent unit.

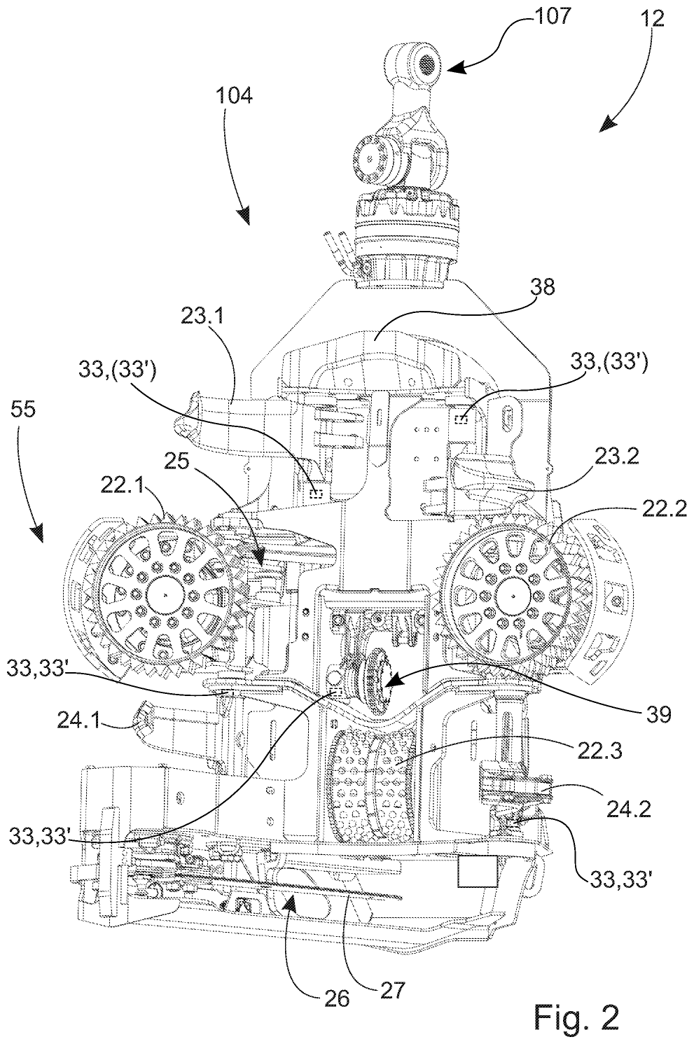

As an example of the measurement device 10, FIG. 1 shows a contact measurement device 10, which is now a caliper 36. The principle of operation of a measurement caliper 36 can be known per se from prior art, operating according to the principle of a slide gauge. It has a fixed measuring insert 36.1 and a measuring insert 36.2 that is arranged to move in the sliding handle 36.3. More generally, instead of measuring inserts 36.1, 36.2, it is also possible to refer to arms of a measurement device 10 provided with a measuring surface. In addition, the caliper 36 has a user interface 40, memory 41, processing unit 44, data transfer interface 42 and data transfer means, and determination means 43 for the lengthwise position, that is, the measuring point M1-Mn. A measuring reel 43′, an electronic measuring tape or an ultrasonic measurement can function as determination means 43 for the lengthwise position. The operation of a caliper 36 is described in the application later, in context with the actual method description. FIG. 2 shows an example of a tree-handling device 12, being now a harvester head 104. A harvester head 104 is an assembly, which is connected, for example, via a rotator 103 (FIG. 1), i.e., a rotating device, to a shackle 107 partly located at the end 101 of the boom assembly 102 of a work machine 11. FIG. 2 shows only the piece of the shackle 107 that is on the side of the harvester head 104.

For performing the functions of the harvester head 104, the harvester head 104 includes actuators, which may be hydraulic cylinders or motors. It is also possible to refer to contact functions 55 of the harvester head 104. They operate, for example, the delimbing knives 23.1, 23.2, 24.1, 24.2 of the harvester head 104 of FIG. 2 opening and closing them, feeding rollers 22.1-22.3 rotating them, and the opening and closing mechanism 25 of the feeding rollers 22.1, 22.2. In the embodiment shown for the harvester head 104, there are two opposite pairs of rotatable delimbing knives 23.1, 23.2, 24.1, 24.2, one pair at each side of the opening and closing feeding rollers 22.1, 22.2. In addition, there is one fixed delimbing knife 38 in the frame of the harvester head 104.

Instead, in the embodiment of the harvester head 104 shown in FIG. 2, there are three feeding rollers 22.1-22.3. Of these, one pair of feeding rollers 22.1, 22.2 is openably closable against each other. One of the feeding rollers 22.3 is fitted fixedly, that is, arranged rotatably in the frame of the harvester head 104. It is arranged in connection with the lower pair of delimbing knives 24.1, 24.2. Delimbing knives 23.1, 23.2, 24.1, 24.2, 38 are used to delimb trunks removing their branches 105. In connection with delimbing, delimbing knives also locally break the tree bark at the same time. Feeding rollers 22.1-22.3, in turn, are used to feed the trunk through the harvester head 104. Thus, branches 105 are delimbed with delimbing knives 23.1, 23.2, 24.1, 24.2, 38. In the case of big trunks, feeding can take place assisted by the boom assembly 102 in a manner known per se. Here, delimbing and feeding through the harvester head 104 can be understood as log processing. The cutting device 26 may be a chain saw 27, for example.

The harvester head 104, more generally, a tree-handling device 12 and/or a work machine 11 also includes determination means 33′. They perform measurement and/or estimation of the diameter d1-dn of the tree 106 and/or the log that has been run through the harvester head 104 and the corresponding lengthwise position m1-m2 of the tree 106 and/or the log producing their determination result. For example, determination means 33′ are sensors 33 in the embodiment shown in FIG. 2. They measure the different functions of the harvester head 104, such as the position of rotatable delimbing knives 23.1, 23.2, 24.1, 24.2, the position of rotatable feeding rollers 22.1, 22.2, and the rotation of one or more measuring wheels 39 and/or feeding rollers. A measuring wheel and/or feeding roller, more generally, contact functions 55, are used to measure the length and the current lengthwise position of the tree 106 and/or the log that is run through the harvester head 104. In the described embodiment, there is one measuring wheel 39 and it is rotatably arranged in the frame of the harvester head 104.

According to an embodiment, the diameter d1-dn of the tree 106 and/or the log can be established in a manner known per se based on information determined from delimbing knives 23.1, 23.2, 24.1, 24.2 and/or feeding rollers 22.1, 22.2, for example. Again, it is possible to more generally refer to contact functions 55. Delimbing knives 23.1, 23.2, 24.1, 24.2, 38 and feeding rollers 22.1-22.3 move tightly against the surface of the tree 106 and/or the log that is run through the harvester head 104. Thus, based on their position relative to each other, it is possible to computationally determine the diameter of an object run through the harvester head 104 and its changing. In this measurement, it is also possible to utilise the position of the fixed delimbing knife 38 and the feeding roller 22.3. For example, the calculation can be performed as triangulation in a manner known per se. In other words, it is possible to measure the distance of the rotatable knives 23.1, 23.2, 24.1, 24.2 from the fixed knife 38, for example. It is also possible to measure the position of the rotatable feeding rollers 22.1, 22.2 relative to the fixed feeding roller 22.3. Thus, delimbing knives need not be even closed, but diameter information can also be obtained exclusively based on information determined from the feeding rollers 22.1-22.3.

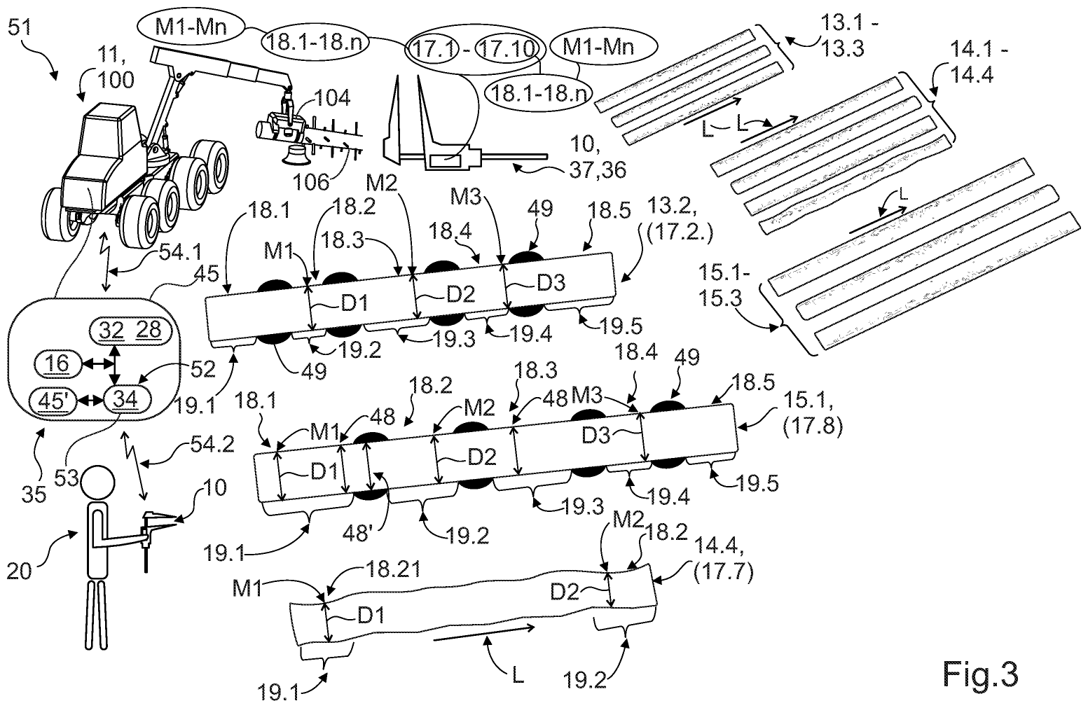

Sensors 33 arranged in the context of the delimbing knives 23.1, 23.2, 24.1, 24.2 and/or feeding rollers 22.1, 22.2 provide, in their various positions, a measurement signal comparable to the position. Using this in the calculation, the thickness d1-dn of the tree 106 and/or the log can be determined in each longitudinal L measuring position m1-mn of the tree 106. It is known that the thickness typically changes in the longitudinal direction L of the tree 106. Thus, the position of the delimbing knives 23.1, 23.2, 24.1, 24.2 and/or feeding rollers 22.1, 22.2 relative to, for example, their pivot points, about which they have been set to rotate, also changes. From this follows a change in the measurement signal provided by the sensors 33. In the described embodiment, the measurement signal or information computed from it is stored, for example, in the memory 32 of the central computer 45 functioning as the control system 35 of the work machine 11 (FIG. 3). The measurement signal can be processed mainly in real time. With the diameter measuring function 16, that is, for example, software for measuring equipment, the measurement signal is changed, in a manner known per se, into the diameter d1-dn of the tree 106 and/or log running through the harvester head 104. The diameter information can be connected, for example, in a manner known per se, to the determination made by the measuring wheel 39 about the current longitudinal L measuring position m1-mn of the tree 106 and/or the log. In other words, position (m1)/diameter (dl) data pairs are formed here with a preset positional accuracy.

In the embodiment shown in FIG. 2, determination means 33′ are illustrated as sensors 33 arranged in a harvester head 104. Just as well or in addition to these, measuring means that is located separately from the tree-handling device 12 can function as determination means 33′. In this case, it can be located, for example, in the work machine 11, in one or more positions. In addition, even a drone, which travels and flies along with the work machine 11, can function as measuring means. For example, arranged in the work machine 11, there may be different diameter sensors or radar equipment for measuring the diameter of the tree 106 and/or the log processed. A tree measured with a lidar can be mentioned as an example. Therefore, running of a tree 106 and/or a log through a tree-handling device 12 can also be extended into processing of a tree 106 and/or a log with a tree-handling device 12. In other words, the diameter of a tree and/or a log can be determined without a need to run them through a tree-handling device 12.

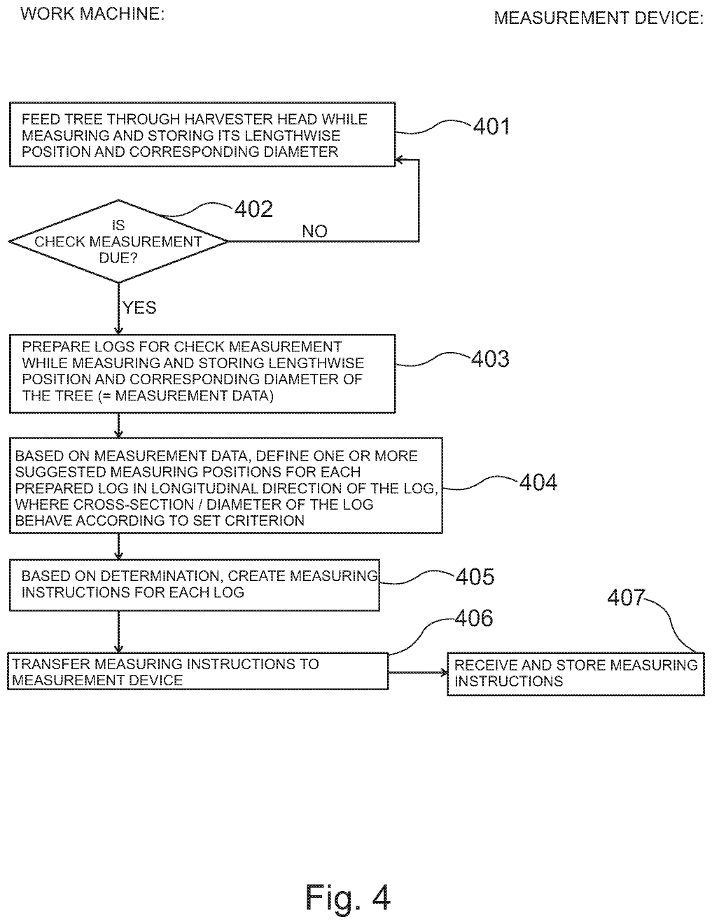

Referring to FIGS. 3 to 8, an embodiment of the invention is described concerning a method for a check measurement of a log processed with a tree-handling device 12. Since the log has already been measured with a tree-handling device 12 in connection with its processing, such as, for example, while preparing it, it is also possible to refer to post-measurement of the log. FIG. 3 is a diagram illustrating the operating environment related to the method and the measurement system 51. In turn, FIG. 4 shows an embodiment according to the method in a flow chart while processing logs with a tree-handling device 12 and preparing them for a check measurement and making preparations for it. In step 401, the tree 106 is fed through the harvester head 104 while simultaneously measuring and storing the lengthwise position m1-mn of the tree 106 and the corresponding diameter d1-dn. At the same time, the tree 106 is also delimbed and cut into logs as the feeding operation proceeds. This is performed in the way described already previously, for example, in the context of FIG. 2. Generally, however, a so-called program for marking for cutting into lengths is used, where the tree 106 is cut according to its dimensions, for example, into suitable cut-to-length logs. This takes place using different diameter classes, for example. Generally, cutting into logs can take place using different length and diameter classes. For example, this is performed, in a manner known per se, with a diameter measuring function 16 run by the central computer 45 of the work machine 11, that is, for example, software for measuring equipment.

If a random draw measurement is concerned, the diameter measuring function 16 of the work machine 11 and/or the tree-handling device 12, that is, for example, software for measuring equipment, draws out the due time of the check measurement based on preset drawing parameters. When the time is due in step 402, the process proceeds to the preparation of logs for a check measurement.

More generally, a check measurement according to the method of the invention may comprise several different things. For example, it may consist of self-monitoring of measuring accuracy, a calibration measurement (verification of measurement difference) for the diameter measuring function 16, that is, for example, software for measuring equipment, and tuning of the diameter measuring function 16 based on it and/or a check measurement (for example, semiannually or on request of a measurement party).

In step 403, logs 13.1-13.3, 14.1-14.4, 15.1-15.3 are prepared with the tree-handling device 12 for a check measurement. While preparing logs, the lengthwise position m1-mn and the diameter d1-dn corresponding to the lengthwise position of the tree 106 and/or the log that is now run through the tree-processing device 12 is measured and stored. More generally, this can be referred to as a measurement performed in connection with log processing. The measurement of the lengthwise position and the corresponding diameter may be mainly continuous and produce measurement data from the diameter of the tree 106 and/or the log, for example, at intervals of 1 cm in the longitudinal direction L of the tree 106 and/or the log. The diameter D and/or the cross-sectional shape of the log may be determined in the tree-handling device 12, for example, based on one or more triangulations that are performed with delimbing knives 23.1, 23.2, 24.1, 24.2, 38 and/or feeding rollers 22.1-22.3. In turn, the lengthwise position is measured, for example, with at least one measuring wheel 39 (FIG. 2). Depending on the determination means 33′, measurement data can just as well be created only after the processing performed with the tree-handling device 12. This is particularly the case if measurement data is created with noncontact determination means, such as, for example, a radar, included in the work machine 11.

In the described embodiment, in step 404, one or more suggested measuring positions 18.1-18.n in the longitudinal direction L of the log are determined for at least part of each log 13.1-13.3, 14.1-14.4, 15.1-15.3 prepared, more generally processed, from the tree 106, for a check measurement. According to an embodiment, suggested measuring positions 18.1-18.n may include one or more measuring areas 19.1-19.n in the longitudinal direction L of the log. Suggested measuring positions 18.1-18.n, such as, for example, measuring areas 19.1-19.n, or even individual measuring points M1-Mn are determined based on the measurement data 28 created in connection with the processing, now the preparation, of the log 13.1-13.3, 14.1-14.4, 15.1-15.3 with the tree-handling device 12. Measurement data 28 may be raw data produced by the diameter measuring function 16, that is, for example, software for measuring equipment, of the work machine 11 and/or the tree-handling device 12 and/or filtered measurement data created from it in a preset manner. In addition, measurement data 28 may also comprise all information that has been created by combining and/or further processing this afore-mentioned data, for example.

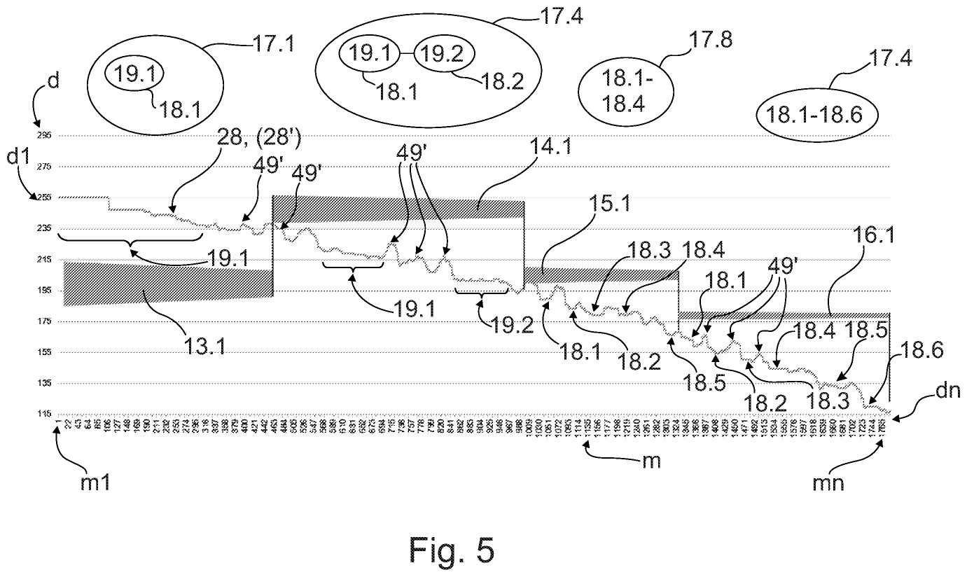

FIG. 5 shows an example of measurement data 28 created in connection with the preparation of a log with a tree-handling device 12. Now, the measurement data shown in the figure is raw data, which is used for computing suggested measuring positions 18.1-18.n. Generally, it is characteristic of suggested measuring positions 18.1-18.n created based on the measurement data 28 and the measuring areas 19.1-19.n included in these that the log diameter behaves in a preset manner in their area. The diameter of the log may then either increase, decrease or even remain mainly constant in the longitudinal direction L of the log. According to an embodiment, the behaviour of the diameter in the area of suggested measuring positions 18.1-18.n may be characterised so that the slope of the graph representing an increasing (or decreasing) diameter (lengthwise position of the log m-diameter d) is relatively small in the area of suggested measuring positions 18.1-18.n compared to the slope of the graph of the diameter elsewhere in the longitudinal direction of the log, which is caused by a local branch knot 49 in the log, which can be produced by a branch whorl, for example. Because a branch knot 49 is often very local, its area in the longitudinal direction of the log may thus be relatively short compared to the extension of the areas, in the longitudinal direction of the log, which allocate the suggested measuring positions for the log. On the other hand, the slope in a suggested measuring position may also be mainly zero or a value near it, if the thickness of the log changes very little in its longitudinal direction L. According to an embodiment, a suggested measuring position 18.1-18.n and, more specifically, the measuring area 19.1-19.n, can also be characterised so that when taking the measurement in it, the likelihood of a human measurement error is smaller than in a log position where the log has deviations. Such a position is expressly a bulge caused by a local branch whorl in the cross section of the log. This can be very difficult for a measurer 20 to observe visually in the log, particularly if bark has also detached from it.

In step 405, a dedicated measuring instruction 17.1-17.10 is created for at least part of the logs 13.1-13.3, 14.1-14.4, 15.1-15.3 prepared, more generally processed, with the tree-handling device 12. The creation of the measuring instruction 17.1-17.10 takes place based on the measurement data 28 created in connection with the preparation of the log 13.1-13.3, 14.1-14.4, 15.1-15.3 with the tree-handling device 12 in step 402. Hence, it can be stated that the measuring instruction 17.1-17.10 for logs is log-specific for at least part of the logs that are prepared, more generally, processed with the tree-handling device 12 for a check measurement. The measuring instruction 17.1-17.10 is based on measurement data 28. For example, measurement data 28 has been created based on the measurement performed by the diameter measuring function 16 of the work machine 11 and/or the tree-handling device 12, that is, for example, software for measuring equipment, in connection with the processing of the log 13.1-13.3, 14.1-14.4, 15.1-15.3 with the tree-handling device 12. By utilising the raw data 28′ of the diameter measurement and information provided by all diameter sensors 33 in the creation of the measuring instruction, it is possible to exactly identify any deformations appearing in the trunk, for example. These affect the reliability of the measurement, such as, for example, when later tuning the diameter measuring function 16 of the tree and/or the log in step 804 based on the performed accuracy determination.

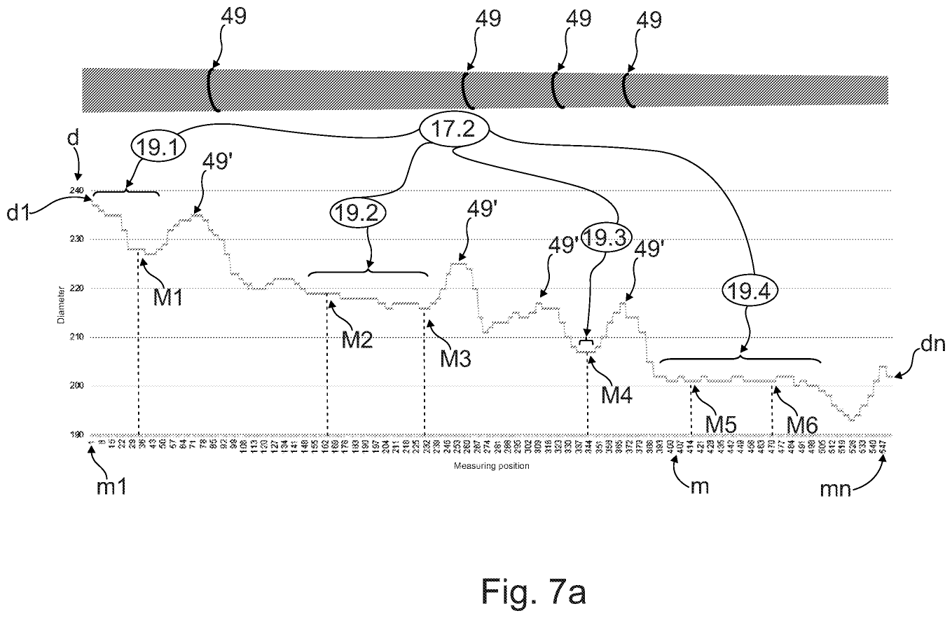

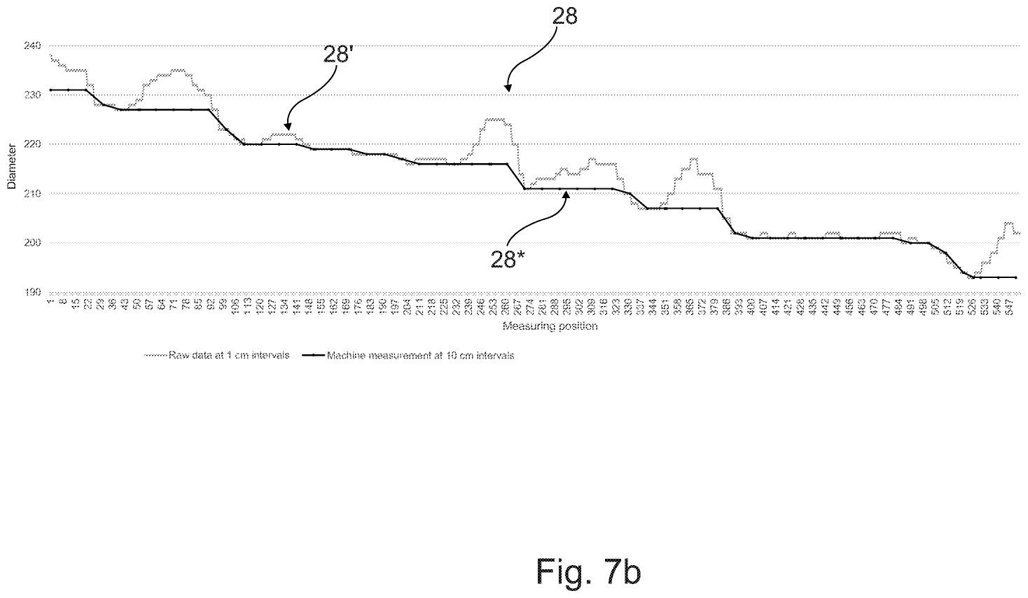

When unfiltered raw data 28′ and filtered measurement data 28* (FIG. 7b) created in connection with the processing performed with the tree-handling device 12 are used according to the method, for example, in addition to one or more standard measuring points 48, it is possible to calculate approximately 10 to 20 measuring points M1-Mn per trunk defined according to the method. Thus, tuning of the diameter measurement of the work machine 11 and/or the tree-handling device 12 becomes much more reliable than with mere standard measuring points 48. According to an embodiment, a caliper measurement can also be performed using exclusively adaptive measuring points M1-Mn, that is, measuring points according to the invention. For example, this is the case when fixed measuring points, that is, standard measuring points 48 for logs have not been laid down in the Timber Measurement Act or Regulation. And this is also the case when it is not necessary to calculate the volume, for example. In other words, if only log diameter measurement is compared. FIG. 5 shows one example of measurement data 28 created in connection with the preparation of a log with the tree-handling device 12 and of a measuring instruction 17.1-17.4 created based on it for logs 13.1, 14.1, 15.1, 16.1 to be prepared from a tree 106. The measurement data 28 shown in FIG. 5 is raw data 28′. Thus, it shows branch knots 49, for example. Branch knots 49 are visible in raw data 28′ in the longitudinal direction L of the log 13.1, 14.1, 15.1, 16.1 first locally as a slightly increasing log diameter and then, immediately thereafter, as a decreasing log diameter. In other words, they are displayed as ridges in the graph of raw data 28′. The locations of branch knots 49 are indicated with reference number 49′ in the graph of FIG. 5. Instead, in filtered measurement data formed from raw data 28′, these diameter changes caused by branch knots 49 are not displayed in a similar way, because data has been filtered there. This will be discussed later in the description part of the application.

An exemplary criterion for determining a measuring point M1-Mn may be that, based on measurement data 28, locations are searched where the log diameter first locally increases and then decreases due to a branch knot 49, for example (or vice versa, depending on the processing direction of the log, for instance). An exemplary criterion may also be that an increasing log diameter is not permitted, if the tree is run through the harvester head 104 in such a way that its diameter decreases as delimbing proceeds. In other words, measuring points M1-Mn are determined for logs only for areas where the log diameter only decreases.

A first exemplary method for characterising the imposition of a measuring point M1-Mn in the level of principle may be that, for imposing a measuring point, one or more positions or areas are determined in the longitudinal direction L of the log 13.1-13.3, 14.1-14.4, 15.1-15.3 where there is a local deviation in the diameter D1-Dn of the log 13.1-13.3, 14.1-14.4, 15.1-15.3, in its longitudinal direction. In this deviation, the log diameter, which is otherwise constant or changes uniformly, both increases and decreases, or vice versa. This increase and then the decrease of the diameter take place within a relatively short distance in the longitudinal direction of the log. Thus, the measuring point is then imposed outside such one or more positions or areas defined. In other words, such a position or area is discarded and left out from the determination of measuring points due to the deviation that appears in it.

Correspondingly, another exemplary method for characterising the imposition of a measuring point M1-Mn in the level of principle may be that, for imposing a measuring point M1-Mn, one or more areas are determined in the longitudinal direction L of the log 13.1-13.3, 14.1-14.4, 15.1-15.3 where the diameter D1-Dn of the log 13.1-13.3, 14.1-14.4, 15.1-15.3 does not change substantially or changes uniformly in such a way that the diameter between the start point and the end point of the area either increases or decreases in the longitudinal direction L of the log 13.1-13.3, 14.1-14.4, 15.1-15.3. Then, one or more measuring points are selected from the one or more areas thus defined. In other words, this area can thus be defined, for its start point and end point, by positions affected by a branch knot. Between these branch knots, the log shape behaves in the preset way.

Still another third exemplary method for characterising the imposition of a measuring point M1-Mn in the level of principle may be that, for imposing a measuring point M1-Mn, at least one position or area is determined in the longitudinal direction L of the log 13.1-13.3, 14.1-14.4, 15.1-15.3 where the diameter D1-Dn of the log 13.1-13.3, 14.1-14.4, 15.1-15.3 does not change substantially or changes uniformly in such a way that the diameter, before and after the measuring point M1-M2, either increases or decreases in the longitudinal direction L of the log 13.1-13.3, 14.1-14.4, 15.1-15.3. In other words, this prevents positioning a measuring point in the area of a branch knot, for example. In the area surrounding the branch knot, the diameter of the log behaves exactly in this way, changing in both directions. As can be seen from the examples, several alternative principles may exist for determining measuring points and areas or they can be applied in different ways as different combinations.

According to an embodiment, the creation of a measuring instruction 17.1-17.4 for each log 13.1, 14.1, 15.1, 16.1 based on a determination according to measurement data 28 can be performed so that raw data 28′ and filtered data 28* are used together in the determination. FIG. 7b shows an example of the appearance of this data in an exemplary log. In raw data 28′, measuring points m1-mn may be spaced at an interval of 1 centimetre. Instead, in filtered data 28*, measuring points may be spaced at an interval of 10 cm. An appearance of a branch knot as a ridge in raw data 28′ was already discussed in the above description. Such a ridge is not visible in filtered data 28*. Here, the graph is either substantially horizontal or only descending (or ascending, depending on the processing direction of the log and the selected coordinate system) in the longitudinal direction L of the log. In other words, increasing diameter values, for example, are removed from the data by filtering with a suitable method. Thus, increasing diameter values are not permitted but only a constant or decreasing diameter is allowed. Thus, filtered data 28* does not then include similar ridges to those in raw data 28 which ascendingly descend at branch knots. Filtered data 28* alone does not give reliable information as to which of the log areas are free from branch knots. This is because they can show in it as a flat line graph and not as a locally ascending and then immediately thereafter descending graph that is typical for raw data 28′, for example. Raw data 28′ provides an additional safety factor for the determination, when it is included in the determination. Branch knots 49/other deformations have not been removed from the data produced by a grapple sensor 33, i.e., raw data 28′.

According to an embodiment, filtered data 28* may function as basic data topped by raw data 28′. However, filtered data 28* and raw data 28′ are first processed separately. Certain representative facts can be searched from them. After this, data groups 28*, 28′ are summed up, which provides their summation information. One or more mathematical models are used in the summation information of the data groups. These may be different filters or trunk models (depending on the tree type, for example). In addition to these, the analysis may be based on the log length. It is possible to examine the slopes of summation information, raw data 28′ and/or filtered data 28* at certain measuring intervals/areas and/or at certain measuring points. From these, advantageous and disadvantageous measuring positions can be identified. Based on this identification, the selection of measuring areas and points is further specified. In this way, it is possible to find representative and non-representative measuring points and areas, from which log-specific measuring instructions are created. Based on the principles listed above, it is possible to determine the location of branch knots 49 and, based on them, define suitable measuring areas 19.1-19.n, which are free from branch knots 49 and, more generally, deviations affecting the measurement. In other words, when defining measuring areas 19.1-19.n and points M1-Mn, it is possible to utilise one or more algorithms, which identify and eliminate branch knots 49. The methods may be digital, analog, computational and/or mechanical. For filtering, it is possible to use generally known statistical methods and/or signal processing. With filtering, the measurement signal of raw data 28′ has been cleaned in such a way that errors and noise are eliminated from the measurement data whereas actual diameter changes remain visible in filtered data 28′.

According to an embodiment, for example, raw data 28′ may convey information for each measuring position m1-mn, if the driver has controlled measurement devices, i.e., feeding rollers or front knives, to release from the trunk of the tree 106. More generally, it is possible to refer to contact functions 55 of a tree-handling device 12 where determination means 33′ connected to them are used to create measurement data 28 in connection with the processing of logs 13.1-13.3, 14.1-14.4, 15.1-15.3 concerning the lengthwise position m1-mn and the corresponding diameter d1-dn of the logs 13.1-13.3, 14.1-14.4, 15.1-15.3. In this case, an internal parameter can be provided in raw data for each measured value, for example, or this parameter is provided when the release begins and when it ends (release control=True/False). In other words, status data of contact functions 55 is thus created and stored concerning the measurement of the lengthwise position m1-mn and/or the corresponding diameter d1-dn. Status data is related to the current position of contact functions 55 relative to the log 13.1-13.3, 14.1-14.4, 15.1-15.3 processed. Thus, leaps in raw data would surely be caused by faults or deviations appearing in the trunk. In the same way, it would be known more reliably when the measurement device has returned down and contacts the trunk. And even otherwise, this makes it possible to know when the machine has actually taken the measurement. These measuring positions need not be compared or used for tuning. However, the described embodiment eliminates and takes into account operations, possibly performed by the driver, that worsen the measurement. Therefore, status data of the contact functions 55 of a tree-handling device 12 can be used to create a measuring instruction 17.1-17.10.

According to an embodiment, in addition to determining the diameter D of the log 13.1-13.3, 14.1-14.4, 15.1-15.3 while preparing, more generally, processing the log 13.1-13.3, 14.1-14.4, 15.1-15.3 with a tree-handling device 12, it is also possible to define the cross-sectional shape of the log 13.1-13.3, 14.1-14.4, 15.1-15.3, such as, for example, ellipticity, in its longitudinal direction L. Information concerning this defined cross-sectional shape of the log 13.1-13.3, 14.1-14.4, 15.1-15.3 can also be used for creating a measuring instruction 17.1-17.10 for the log 13.1-13.3, 14.1-14.4, 15.1-15.3. In other words, if the log is highly elliptic for some of its areas, it is not necessarily suggested/instructed to take a check measurement with a caliper 36 or an equivalent device 10 in this area. Typically, if ellipticity exists, it exists more in the base of the tree 106, 10-20 mm, for instance, and less in the top, 2-5 mm, for instance. However, if ellipticity exists, it usually appears over the entire length of the tree 106.

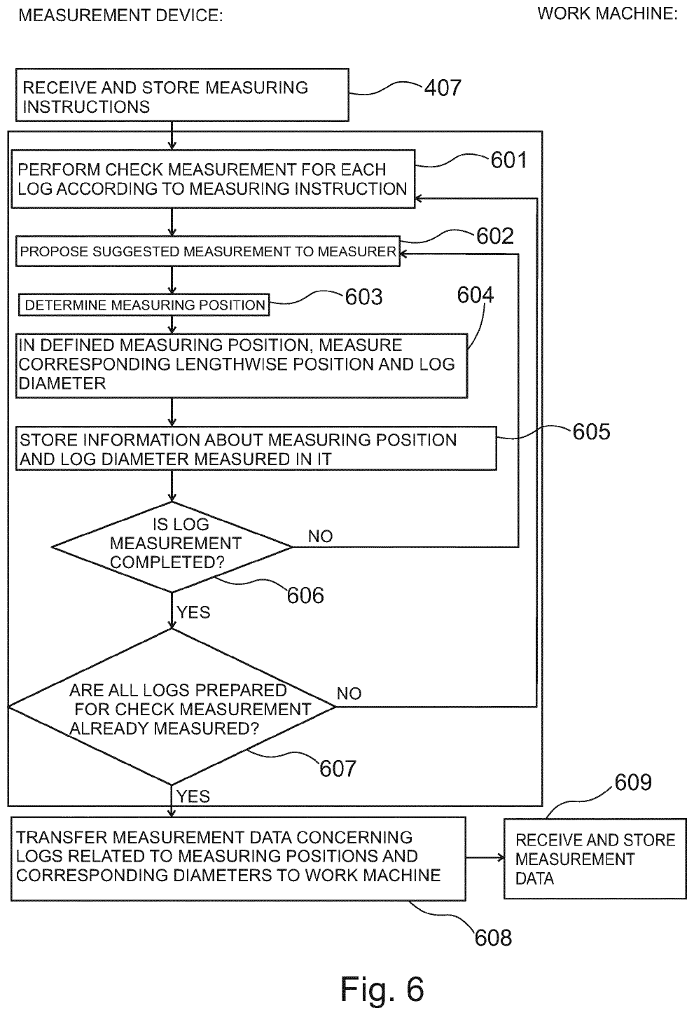

In step 406, measuring instructions 17.1-17.10 created are transferred to the measurement device 10 and, in step 407, measuring instructions 17.1-17.10 are received at the measurement device 10 and stored in the memory 41 of the measurement device 10 for the following check measurement of logs to be performed with it. FIG. 6 shows an embodiment according to the method in a flow chart while performing a check measurement of logs 13.1-13.3, 14.1-14.4, 15.1-15.3 with a measurement device 10. In step 601, the check measurement is performed for each log 13.1-13.3, 14.1-14.4, 15.1-15.3 in accordance with a measuring instruction 17.1-17.10 individually created for them. Step 601 may include several substeps 602-607 for measuring each log 13.1-13.3, 14.1-14.4, 15.1-15.3 separately according to the method using a dedicated measuring instruction 17.1-17.10 in measuring positions M1-Mn that deviate from each other at least partly or even completely. In the check measurement performed with the measurement device 10, the diameter D1-Dn of at least one log 13.1-13.3, 14.1-14.4, 15.1-15.3 processed, such as, for example, prepared, with the tree-handling device 12 in step 403 is measured with the measurement device 10. The measurement is performed at one or more longitudinal L measuring points M1-Mn, 48 of the log 13.1-13.3, 14.1-14.4, 15.1-15.3. These measuring points M1-Mn, 48 include one or more measuring points M1-Mn determined based on the measurement data 28 created in connection with the processing of the log 13.1-13.3, 14.1-14.4, 15.1-15.3 with the tree-handling device 12. Now, the processing of logs has been preparation of them. Thus, the measuring points M1-Mn are obtained based on the measurement data 28 of the diameter measuring function 16, that is, for example, software for measuring equipment, of the work machine 11 and/or the tree-handling device 12 and imposed by the diameter measurement function 16, that is, for example, software for measuring equipment.

According to an embodiment, in the substep 602 of the check measurement performed with the measurement device 10, for example, a suggestion 18.2 can be made to the measurer 20 for the first measuring position M1. Thus, for at least part of the logs 13.1-13.3, 14.1-14.4, 15.1-15.3 measured in step 601, the measuring instruction 17.1-17.10 for the log 13.1-13.3, 14.1-14.4, 15.1-15.3 includes one or more suggested measuring positions 18.1-18.n. Furthermore, suggested measuring positions 18.1-18.n may include one or more measuring areas 19.1-19.n in the longitudinal direction L of the log 13.1-13.3, 14.1-14.4, 15.1-15.3. One or more measuring positions M1-Mn are selected or imposed from the measuring areas 19.1-19.n while measuring the log 13.2.

In step 603, a decision can be made on the actual exact measuring point M1 in the log 13.2 based on the suggested measuring position 18.2 included in the measuring instruction 17.2 for the log 13.2 (FIG. 3). Thus, in the measuring instruction 17.2 for the log 13.2, at least one measuring point M1 in the longitudinal direction L of the log 13.2 is arranged as a suggested measuring position 18.2 and, more specifically, as a measurement area 19.2 and a measuring point M1 determined within it for measuring the diameter D1 of the log 13.2 with the measurement device 10. Thus, from one or more suggested measuring positions 18.1-18.n and, more specifically, from the measuring areas 19.1-19.n defined by them, one or more measuring points M1-Mn are suggested, selected or imposed for the measurement of the log 13.1-13.3, 14.1-14.4, 15.1-15.3 with the measurement device 10.

In step 604, the diameter D1 of the log 13.2 is measured at the selected measuring point M1. In addition to the diameter measurement, the lengthwise position of the log 13.2 corresponding to the measuring point M1, at which the diameter was measured, may also be possibly verified. More generally, in step 604, in connection with the measurement of the diameter D1-Dn of the log 13.1-13.3, 14.1-14.4, 15.1-15.3, the measurement device 10 is used to measure the diameter D1-Dn of the log 13.1-13.3, 14.1-14.4, 15.1-15.3 at a measuring point M1-Mn located in at least one measuring area 19.1-19.n. The measurement is performed as a crosswise measurement, if the measurement device 10 is a caliper 36.

As mentioned above, there may be several alternative procedures. According to a first embodiment, while measuring the log 13.2 with the measurement device 10, the measurer 20 is instructed to measure at least one measuring point M1 from the measuring area 19.2 included in the suggested measuring position 18.2, more generally, the measuring instruction 17.2, in which the measurer 20 performs the diameter measurement of the log 13.2. According to a second embodiment, the measurer 20 can select at least one measuring point M1 in the log 13.2 from the measuring area 19.2 included in the suggested measuring position 18.2, more generally, the measuring instruction 17.2. According to a third embodiment, at least one measuring point M1 in the log 13.2 from the measuring area 19.2 included in the suggested measuring position 18.2, more generally, the measuring instruction 17.2, is suggested to the measurer 20. According to a fourth embodiment, the measurement device 10 can measure even automatically in at least one measuring area 19.2 included in the suggested measuring position 18.2, more generally, the measuring instruction 19.2, and/or at a measuring point M1 defined from it. Of these, one or more alternative procedures can be implemented in the same embodiment, i.e., in the check measurement, or even in the context of the same log 13.2. Most typically, the measurer 20 and/or the measurement device 10 can be informed of the exact position M1 or at least the measuring range or area 19.2, in which the measurement should be taken with the measurement device 10. If the measurer 20 is allowed to freely select the measuring point M1 from the area, at least in this case the corresponding positional information M1 is determined and stored. When the measuring position M1 is imposed, storing the positional information M1 may in this case function as verification for the measuring position.

FIG. 7a shows an example of measurement data 28 created from one log 13.2 being now mere raw data 28′ and an embodiment of a measuring instruction 17.2 created from it. As suggested measuring positions 18.1-18.4, the measuring instruction 17.2 now includes measuring areas 19.1-19.4, in which the measurement can be performed according to the method of the invention. As already described previously, in the measuring area 19.1-19.4 or measuring position, the diameter D1-Dn of the log 13.2 is uniformly changing (increasing or decreasing) or mainly constant, i.e., unchanging, for example. Thus, the diameter D of the log 13.2 either decreases or increases over a length that is relatively large and required for accuracy, without essential leaps 49′, i.e., slope changes in the diameter. The length, over which a change takes place, may also be very short, such as, for example, the measuring area 19.3 in FIG. 7a. For example, laser measurement enables a measurement of very short distances. If the measurement device 10 uses reel measurement to determine the measuring position in the longitudinal direction of the log, the lengthwise area from which the measuring point M1 is imposed, may be a section of a few centimetres only. Typically, a branch knot 49, for example, produces a change of 10-50 mm, or in some cases as big as 100 mm, to the diameter of the log 13.2, in both directions (protuberance). Correspondingly, for example, as a consequence of local debarking or a split in a branch whorl, the change may be of a similar type but opposite (local and possibly even a one-sided hole or recess on the surface of the log). The diameter D may also be mainly constant, that is, without essential changes. In the embodiment of FIG. 7a, it can be seen that the measuring area 19.1 has one measuring point M1, the measuring area 19.2 has two measuring points M2, M3, the measuring area 19.3 has one measuring point M4, and the measuring area 19.4 has two measuring points M5 and M6. For example, leaps 49′ formed at branch knots 49 are identified from the measurement data 28 and the measuring point is not set in these areas or in their immediate vicinity. Measuring points are rather in the areas between the leaps 49′ caused by branch knots 49. In these, the diameter changes uniformly, such as, for example, increases or decreases, or is mainly constant, i.e., essentially unchanged. Then, the diameter change is clearly distinguished, for example, from a branch knot 49, bark detached from the log in connection with its processing, surface split from the log in connection with its delimbing, or another similar deviation on the surface or in the shape of the log.

According to an embodiment of the invention, measuring instructions 17.1-17.10 defined based on the measurement data 28 created in connection with the processing of the log 13.1-13.3, 14.1-14.4, 15.1-15.3 with a tree-handling device 12, such as, for example, measuring points M1-Mn, can be used in the case of one or more logs 13.1-13.3, 14.1-14.4, 15.1-15.3 requiring a check measurement either without standard measuring points 48 imposed in the Timber Measurement Act or Regulation or guidelines or together with at least part of them. According to an embodiment of the invention, based on the measurement data 28 created in connection with the processing of the log 13.1-13.3, 14.1-14.4, 15.1-15.3 with a tree-handling device 12, unreliable measuring points 48′ can be filtered out from standard measuring points 48 and/or the weighting of standard measuring points 48 can be reduced. In other words, if it is detected, based on the measurement data 28 created in connection with the work on the tree-handling device 12, that a standard measuring point 48′ is in a deviating area in the log, such as, for example, a branch knot 49, it can be instructed that the standard measuring point 48′ remains unmeasured or, alternatively, a lower weighting is given to the measurement result measured at it.

In step 605, information is stored, for example, in the memory 41 of a measurement device 10 concerning the lengthwise position of the log 13.2 measured with the measurement device 10, i.e., the measuring point M1, and at least to the diameter D1 of the log 13.2 measured at this measuring point M1 with the measurement device 10.

In step 606, it is examined if the log 13.2 subjected to the measurement is already completely measured. If this log 13.2, currently subjected to the measurement, has other remaining measuring points M2-Mn based on its measuring instruction 17.2, the next measuring point in its longitudinal direction L, for example, the measuring point M2 imposed by the measuring instruction 17.2 is entered. This next measuring point M2, too, may have been determined based on the measurement data 28 created in connection with the processing of the log 13.2 with the tree-handling device 12. Here, too, steps 602-605 are repeated in the same way as already described above. If standard measuring points, which are to be measured, are encountered inbetween, these are also measured. Thus, another measuring point M2 is imposed from the measuring instruction 17.2 created for the log 13.2, which may be included in another suggested measuring position 18.3, which is in the form of another measuring area 19.2 in the embodiment presented.

Instead, if it is discovered in step 606 that the entire log 13.2 is already measured, that is, all measuring points M1-Mn, 48 defined for the log 13.2 have been processed with the measurement device 10, step 607 is entered. In step 607, it is examined whether all logs 13.1-13.3, 14.1-14.4, 15.1-15.3 made for the check measurement have already been measured. If unmeasured logs 13.3, 14.1-14.4, 15.1-15.3 still exist, step 601 is returned to and steps 602-605 follow as above. In other words, the successive log 13.3 of the set is measured next. For this, too, its own measuring instruction 17.3 including suggested measuring positions 18.1-18.n and measuring areas 19.1-19.n included in these may have been created, of which one or more measuring points M1-Mn are imposed for performing the check measurement with the measurement device 10. As stated, instead of a measuring area, the measuring position of the log imposed from the measurement data 28 may also be an exact measuring point, taking into account the accuracy of the determination tool 43 for the lengthwise position of the measurement device 10, such as, for example, a measuring reel 43′.

If it is discovered in step 607 that there are no remaining unmeasured logs, step 608 is entered. In step 608, the measurement results 30 concerning the logs 13.1-13.3, 14.1-14.4, 15.1-15.3 regarding the measuring points M1-Mn, at which the diameter measurement has been performed, and the corresponding diameters D1-Dn, can be transferred to the work machine 11 and/or the tree-handling device 12, for example. In step 609, for example, the work machine 11 and/or the tree-handling device 12 receives the measurement results 30 from the measurement device 10. In addition, it stores them in its memory 32 for processing/further analysis of the measurement results 30. Measurement results 30 can also be sent to a cloud service for computation/analysis to be performed on them. This can take place independent of place via information networks. It is of course possible to transfer measurement results 30 just as well already when the measurement is still in progress. In this case, it can take place even immediately after each measurement taken at a measuring point.

Furthermore, in this context, reference is made to FIG. 3 and the log 14.4 shown in it, which is badly curved. Owing to the invention, tuning the diameter measurement of the tree-handling device 12 becomes possible for lower-quality trunks, as well. Owing to the invention, it is possible to determine such measuring points M1, M2 for the log 13.4 from the measurement data 28, which can be reliably measured with the measurement device 10 and the tree-handling device 12, for example. It may also be in such way, that bad logs are not necessarily measured at all using adaptive measuring points M1-Mn according to the invention. In this case, standard measuring points 48 still exist for each log and only these are measured. Therefore, a measuring instruction 17.1-17.10 is arranged for at least one log and not necessarily for all those that are subjected to a check measurement.

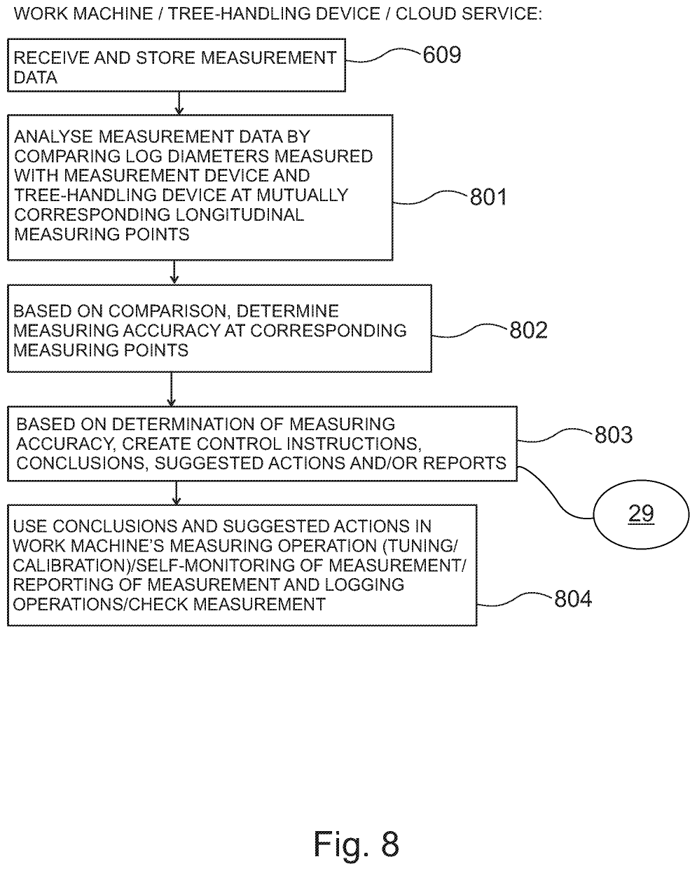

FIG. 8 shows an embodiment according to the method in a flow chart for processing measurement results 30 obtained with the measurement device 10. This can take place in a manner known per se as prior art and also comprises prior art actions, control and reporting. For example, after the work machine 11 has received the measurement results 30 in step 609, they are stored in its memory 32 for analysing the results. For example, this analysis can be performed by the diameter measuring function 16 of the work machine 11 and/or the tree-handling device 12, that is, for example, software for measuring equipment, which is executed with the central computer 45 of the work machine 11, for example. In step 801, measurement data is analysed by comparing the diameters D1-Dn, d1-dn of logs 13.1-13.3, 14.1-14.4, 15.1-15.3 measured with the measurement device 10 and the tree-handling device 12, for example, at mutually corresponding measuring points M1-Mn, m1-mn. Thus, one or more diameters D1-Dn measured with the measurement device 10 of at least one log 13.1-13.3, 14.1-14.4, 15.1-15.3 are compared to the diameter d1-dn measured, for example, in connection with the preparation of the log 13.1-13.3, 14.1-14.4, 15.1-15.3 with the tree-handling device 12 and determined based on it at the mutually corresponding longitudinal L measuring point M1-Mn, m1-mn.

In step 802, based on the comparison, the accuracy of the diameter measurement determined in connection with the processing of the log 13.1-13.3, 14.1-14.4, 15.1-15.3 with the tree-handling device 12 is determined at mutually corresponding longitudinal L measuring points M1-Mn of the log 13.1-13.3, 14.1-14.4, 15.1-15.3. In other words, the correctness of the measurement performed in connection with the processing with the tree-handling device 12 at mutually corresponding measuring points is determined.

In step 803, conclusions, suggested actions and/or reports are created based on the determined accuracy of the measurement. Herein, in step 803, the diameter determination measurement performed in connection with the processing of the log 13.1-13.3, 14.1-14.4, 15.1-15.3 with the tree-handling device 12 is controlled and/or information 29 is created concerning the performed diameter measurement and thereby the determination based on the measuring accuracy defined in step 802. In other words, actions are thus taken based on the correctness of the measuring accuracy. In step 804, conclusions and suggested actions based on the measurement results 30 obtained with the measurement device 10 are used, for example, in the measuring operation of the work machine 11 and/or the tree-handling device 12, such as, for example, maintenance of the accuracy of the diameter measuring function 16 of the work machine 11 and/or the tree-handling device 12, that is, for example, software for measuring equipment, such as, for example, tuning, self-monitoring of measuring accuracy, such as, for example, concerning possible claim cases, reporting of measuring and harvesting activities and/or check measurement of the work machine 11 and/or the tree-handling device 12 (for example, semiannual measurement/measurement performed on request of a measuring party), fault diagnostics of the work machine 11 and/or the tree-handling device 12, measurement quality assurance and/or monitoring and/or adjustment of operation of the work machine 11 and/or the tree-handling device 12. In fact, the end use and utilisation of information do not in any way restrict applicability of the method according to the invention to different situations and applications. Possibilities are thus very versatile.

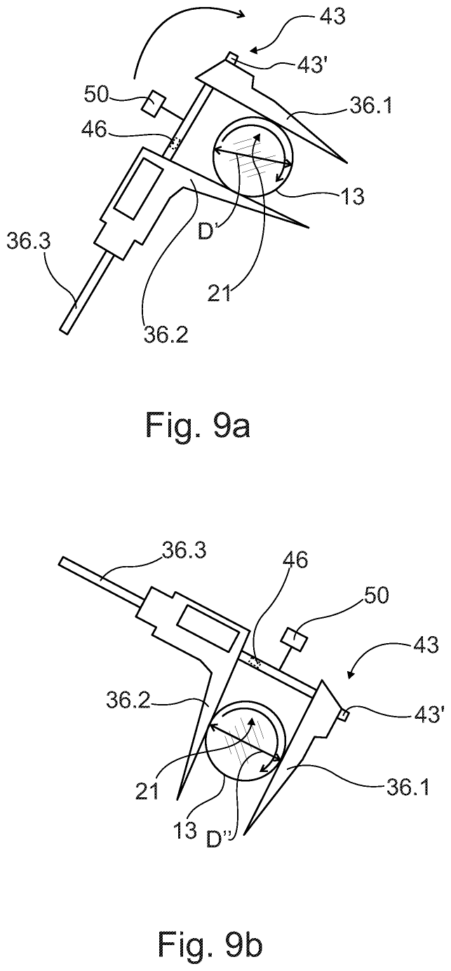

According to an embodiment, for example, step 601 may have a substep consisting of an application of the invention where the measurement device 10 is also used to determine ellipticity or, more generally, the cross-sectional shape of the log 13. Reference is also made to FIGS. 9a and 9b, which show an embodiment for determining ellipticity of the log 13 with a measurement device 10. For this, there are several different methods and embodiments related to the activity concerned. Based on the defined cross-sectional shape, it is possible to determine measuring directions in the circumferential direction 21 of the log 13, in which the diameter measurement of the log 13 can be performed as a crosswise measurement in such a way that ellipticity of the log 13 has less effect on the measurement result.

According to an embodiment, when measuring the diameter D of the log 13 with the measurement device 10 at a measuring point M, the diameter D of the log 13 is measured in two or more positions in its circumferential direction 21 and the corresponding diameter D′, D′A of the log 13 is stored. Information, such as, for example, the average of the diameter D′, D′ A of the log 13 at this longitudinal measuring point M, is created from the diameter measurement of the log 13 in two or more positions in its circumferential direction 21. In addition, a crosswise measuring instruction, based on which the measurement is performed, can be created for this measuring point M from the diameter measurement of the log 13 in one or more positions in its circumferential direction 21. For example, based on the circumferential 21 measurement, two or more crosswise measuring positions are thus retrieved at the concerned measuring point M, at which the measurement is to be taken based on instructions or guidance. In other words, measuring directions that meet the set criteria are defined for the crosswise measurement performed with the measurement device 10 and a crosswise measurement is performed with the measurement device 10 in these defined measuring directions. In this way, any errors caused to the measurement result by ellipticity can be eliminated from the measurement performed with a caliper 36 already in connection with the crosswise measurement performed with the measurement device 10.

According to a second embodiment, when measuring the diameter D of the log 13 with the measurement device 10 at a measuring point M, the diameter D of the log 13 can be measured in its circumferential direction 21 even as a continuous measurement, while storing the diameter D of the log 13 at the same time, i.e., in connection with the measurement. Thus, more than two measurements are taken from the same measuring point M. During the measurement, when detecting based on a measurement rotated in the circumferential direction, ellipticity at one measuring point M that conforms to the set criterion, such as, for example, exceeding 7 mm, an alert can be given. Based on this, it is possible, for example, to discard this measuring point M in the longitudinal direction L of the log 13, if suitable measuring positions for the caliper 36 are not found at this measuring point M.

Based on the above, according to an embodiment, the caliper 36 can also be arranged to include its position measurement. One or more position sensors 46 arranged in the caliper 36 provide reliable information on ellipticity of logs 13 for a caliper measurement. According to an embodiment, the caliper 36 may instruct the measurer 20, in one or more adaptive measuring positions M1 of the log 13 and/or at a standard measuring point 48, to clamp the caliper 36 with a normal clamping force and simultaneously rotate the caliper 36 at least 90 degrees while the caliper 36 is at an angle of 90 degrees relative to the longitudinal axis L of the log 13. Thus, the diameter is measured in more than two measuring positions of the measurement device 10. Furthermore, the same rotation can also be made in the opposite direction to verify the measurement. Thus, the caliper 36 continuously measures the diameter D of the log 13 while rotating it around the log in the circumferential direction 21; in other words, several pairs of diameter/posit ion points are then stored. Based on the measurement performed, correct measuring directions can be computationally retrieved for the best crosswise measurement. For example, after the rotational measurement and determination, the caliper 36 indicates the correct position for this measuring point M1, for example, on the display of the caliper 36 and/or with an audible signal once the defined measuring position has been reached. If bark has detached from this measuring point M1, then this measuring point M1 can be skipped and the corresponding action can be performed at the following measuring point M2, for example. The selection of the measuring point M1-Mn and the measurement of ellipticity can be made even more reliable with a camera 50 arranged in connection with the caliper 36, for example. With this, it is possible to verify if bark has detached from this measuring point M1 or if there are other corresponding deviations that may affect the measurement, for example.

In other words, based on the above, the crosswise measurement can be controlled based on ellipticity determination of the log 13. It indicates one or more measuring directions for guiding the measurement for the measurer 20 and gives a signal to the measurer 20, when a position sensor 46 detects that the measurement device 10 is in the position according to the defined measuring direction. Thus, the measurer 20 is guided based on the ellipticity determination. For example, the measurer 20 may first take one measuring point and then guidance can be given to know at how big intervals in the circumferential direction 21 the following one or more diameter measurements are taken. For example, one point may be guided or then several points are guided. In a rectangular measurement, the measurement device 10 gives an indication, such as, for example, an audible signal, once it has been rotated by 90 degrees relative to the first measuring position. This embodiment and a caliper with such a function can be utilised in context with this invention, however, just as well independent of this invention.

Thus, a position measurement arranged in a caliper is not necessarily tied to the use of adaptive measuring points. The caliper has a processor connected to a position sensor and necessary program codes for execution with the processor and arranged to provide the afore-mentioned functions and substeps in connection with the performance of the measurement. The processor also controls the input and output means of the caliper, which are related to this embodiment. On the other hand, information about ellipticity of the log 13 can also be obtained, instead of or in addition to the measurement device 10, from the delimbing knives and/or feeding rollers of the tree-handling device 12, for example, when the technology enables it in the future. This information, too, can be used for determining, for example, adaptive measuring points M1-Mn.

Adaptive measuring points M1-Mn, more generally, measuring instructions 17.1-17.10 including or defining these, can be defined, based on the measurement data 28, with the central computer 45 of the work machine 11 or the tree-handling device 12, for example. Just as well, they can also be determined as a cloud service somewhere else, for example. In addition, they can also be determined in the measurement device 10 itself. Thus, regarding the invention, it is not essentially significant where the measuring instruction 17.1-17.10 for each log is determined, it is not tied to a place. The measuring instruction 17.1-17.10 can be created in any step. The creation of one individual instruction may take place in several places and/or in successive steps, for example.

Data can be transferred via an information network for both the measurement data 28 and the measuring instruction 17.1-17.10 created from it. Similarly, measurement results 30 created with the measurement device 10 can be transferred for processing to a work machine 11, a tree-handling device 12, a cloud service, such as, for example, for an analysis by third parties, to a mobile device, a portable computer, or measurement results 30 can be analysed in the measurement device 10 itself. An analysis and comparison of measurement results 30 and action performed based on them are not also tied to a place or critical as regards the invention.

For example, according to an exemplary embodiment, for example, in step 401, the diameter measuring function 16 of the work machine 11 and/or the tree-handling device 12 can be analysed by a third party. When deviations are detected in the measurement results of the work machine 11 and/or the treehandling device 12, a decision is made in step 402 that the following trunks are measured. Thus, a continuous online data link may exist between the work machine 11 and/or the treehandling device 12 and the party who performs an online, i.e., mainly real-time analysis of the measurement results of the work machine 11 and/or the tree-handling device 12. A part or all of the measuring instructions 17.1-17.n may also come from the caliper 36, a part from the work machine 11 and a part from a third party who analyses the measurement data 28, for example. A check measurement can be started for different reasons. Measuring instructions 17.1-17.10 can also be changed even during a measurement that has already been started with the measurement device 10.

In addition to the method, the invention also relates to a measurement system 51 for a check measurement of a log 13.1-13.3, 14.1-14.4, 15.1-15.3 processed with a tree-handling device 12. The system includes a tree-handling device 12, which is arranged to process, such as, for example, prepare logs 13.1-13.3, 14.1-14.4, 15.1-15.3. The system also includes determination means 33′ arranged to create measurement data 28 in connection with the processing of logs 13.1-13.3, 14.1-14.4, 15.1-15.3. The measurement data 28 created concerns the lengthwise position m1-mn and the corresponding diameter d1-dn of the logs 13.1-13.3, 14.1-14.4, 15.1-15.3 at each longitudinal L measuring point m1-mn, i.e., lengthwise position of the log. Determination means 33′ may be located, for example, in the tree-handling device 12 and/or the work machine 11.

Furthermore, in the described embodiment, the system may also include a measurement device 10, such as, for example, a caliper 36. The measurement device 10 is meant for measuring the diameter D1-Dn of a log 13.1-13.3, 14.1-14.4, 15.1-15.3 processed with a tree-handling device 12 at one or more longitudinal L measuring points M1-Mn of the log 13.1-13.3, 14.1-14.4, 15.1-15.3. As one of its parts, the system may also have one or more processors 45′ and memory 32 connected to it. Of these, at least one processor 45′, such as, for example, the processor 45 of the control system 35 of the work machine 11, is arranged to compare the diameter d1-dn of a log 13.1-13.3, 14.1-14.4, 15.1-15.3 based on the measurement data 28 created with the determination means 33′ to the diameter D1-Dn of a log 13.1-13.3, 14.1-14.4, 15.1-15.3 measured with the measurement device 10. The comparison is performed at least at some of the mutually corresponding longitudinal L measuring points M1-Mn of the log 13.1-13.3, 14.1-14.4, 15.1-15.3.

The at least one processor 45′ included in the measurement system 51 is arranged to create a measuring instruction 17.1-17.10 for at least one log 13.1-13.3, 14.1-14.4, 15.1-15.3 based on the measurement data 28 created in connection with the processing of the log 13.1-13.3, 14.1-14.4, 15.1-15.3 with the tree-handling device 12. In addition, the at least one processor 45′ included in the measurement system 51 is arranged to compare one or more diameters D1-Dn of at least one log 13.1-13.3, 14.1-14.4, 15.1-15.3 measured with the measurement device 10 to the diameter d1-dn determined in connection with the processing of the log 13.1-13.3, 14.1-14.4, 15.1-15.3 with the tree-handling device 12. The at least one processor 45′ included in the measurement system 51 is also arranged to determine, based on the comparison, the accuracy of the diameter determined in connection with the processing of the log 13.1-13.3, 14.1-14.4, 15.1-15.3 with the tree-handling device 12. The at least one processor 45′ included in the measurement system 51 is further arranged to control the diameter determination performed in connection with the processing of the log 13.1-13.3, 14.1-14.4, 15.1-15.3 with the tree-handling device 12 and/or create information 29 concerning the diameter determination based on the determined measuring accuracy.

The measurement device 10 is arranged to be instructed to measure the diameter D1-Dn of at least one log 13.1-13.3, 14.1-14.4, 15.1-15.3 processed, such as, for example, prepared, with the tree-handling device 12 according to the measuring instruction 17.1-17.10 created for the log 13.1-13.3, 14.1-14.4, 15.1-15.3.

At least one processor 45′ of the system is arranged to perform substeps of the method according to the invention.

In addition to a method and a measurement system, the invention is also related to a forest machine 100. The forest machine 100 is arranged to perform one or more substeps of the method. In addition, the forest machine 100 may be a part of the aforementioned system or it is arranged to perform one or more substeps and/or functions according to the method described above. In the case of a forest machine 100, the tree-handling device 12 may be a harvester head 104, which is arranged in a work machine 11, such as, for example, a forest machine 100.

According to an embodiment, the forest machine 100 may be a part of the system 51 according to the invention. In this case, the forest machine 100 is equipped with devices required by the measurement system 51 according to the invention already in connection with its manufacture. Alternatively, elements that are necessary for implementing the measurement system 51 can also be arranged in existing forest machines that are in other respects equipped with components required by the measurement system 51. At its simplest, it may be sufficient to merely perform a software update, which forms adaptive measuring points M1-Mn from measurement data 28 specific to each log, which does not include, for example, branch knots 48 or other similar factors that cause inaccuracies in the accuracy of diameter measurement.

Furthermore, an object of the invention is also a computer program product 52 as shown in FIG. 3 for a check measurement of a log processed, such as, for example, prepared, with a tree-handling device 12. The product 52 comprises program code means 34 stored in a medium/storing equipment 53 that is readable with a computer 45. Program code means 34 is arranged to perform steps according to any substep of the method when the program is run with the computer 45.

Program code means 34 may be a part of software or a computer program or computer program product 52, which operates, for example, on a control system 35. According to an embodiment, program code means 34 may also be located remotely as a cloud service, for instance. Thus, data of the control system 35 of the forest machine 100 is sent to programmable means to another location using the remote connection. An object of the invention is also hardware 45 including a memory unit 32 for storing the program code 34 and a processor 45′ for executing the program code 34. In connection with execution, the hardware 45 performs at least some of the steps according to the method. The hardware 45 or at least part of it may consist of the central computer 45 of the forest machine 100, for example.

More particularly, the hardware 45 may include one or more processors 45′ and one or more memories 32 including computer program code 34. In addition, the hardware 45 includes a first interface 54.1 arranged for data transfer concerning measurement data 28 created in connection with the processing of a log 13.1-13.3, 14.1-14.4, 15.1-15.3 with a tree-handling device 12 and another interface 54.2 arranged for data transfer concerning information that is created in the hardware 45 based on measurement data 28 created in connection with the processing of a log 13.1-13.3, 14.1-14.4, 15.1-15.3 with a tree-handling device 12. In the hardware 45, one or more memories 32 and computer program code 34 are configured, together with one or more processors 45′, to provide that the hardware 45 at least creates, based on the measurement data 28 created in connection with the processing of the log 13.1-13.3, 14.1-14.4, 15.1-15.3 with the tree-handling device 12, a measuring instruction 17.1-17.10 for at least one log 13.1-13.3, 14.1-14.4, 15.1-15.3, which is arranged to be used for a check measurement of a log processed with the tree-handling device 12. Therefore, the measuring instruction is information for the second interface 54.2. Thus, the measuring instruction can be created in any place with the processor and even in a decentralised manner, and its creation is not tied to the context of a forest machine or caliper, more generally, a measurement device, for example. The measurement device 10 may be any existing device for checking a measurement. For example, it can be a mechanical measurement device 37, such as, for example, a caliper 36 shown as an application example, a measuring clamp or a measuring tape. It may also be an electronic measurement device, such as, for example, a camera device, a laser device, based on a photocell, infrared, ultrasound or radiation, a radar device or a combination of any of these. The determination means 33′ of the work machine 11 and/or the tree-handling device 12 may also be based on any one or more of these technologies.

The tree-handling device 12 itself can also function as the measurement device 10. Thus, it can be used to determine the diameter of a log for checking purposes after its preparation. In this case, the log is run, as regards delimbing knives, for example, to an area, which definitely does not include branch knots 48 or the like that affect the measurement, and the diameter of the log is measured with a stationary log in this position. Here, too, the measuring position is determined according to the invention based on the measurement data 28, which was created for the log, for example, while preparing, more generally, processing it with the tree-handling device 12. The log to be measured can just as well be a so-called standard log and the measurement taken with it.

Monitoring and/or adjustment of the operation of a work machine 11 and/or a tree-handling device 12, to which the invention also brings improvements, may also include, to provide some non-restricting examples, knife/roller pressures, maintenance needs, sharpening needs of knives and the fuel consumption of the work machine 11 and/or the tree-handling device 12. A higher knife/roller pressure increases the fuel consumption. The accuracy of diameter measurement also has an impact on the stopping of the guide bar of a chain saw 27 in just the right place. Owing to the invention, as a consequence of improved measuring accuracy, a harvester head 104 can be made to operate better in all diameter ranges and, in addition, more optimally.

Owing to the invention, acquisition of a measurement device 10, such as a caliper, 36, also brings savings to a forest machine contractor. The productivity of the harvester increases. Owing to the invention, when measuring, besides the standard measuring points 48 of the log 13, also adaptive measuring points M1-Mn or only adaptive measuring points M1-Mn, the accuracy of diameter measurement of a work machine 11 and/or a tree-handling device 12 can be made much better already with a smaller number of logs prepared for a check measurement. This saves the working time of the driver and thereby also increases the productivity of the work machine 11 and/or the tree-handling device 12. In addition, extraordinary actions are left out from operations. It is often necessary to perform such actions in awkward working conditions, such as, for example, in snow, frost or rain, which may make the measurement difficult. Undersawing, i.e., too early cutting of the log, which causes quality defects, is also avoided when the accuracy of diameter measurement improves. Thus, advantages of the method according to the invention are manifold.

The invention also benefits the end client. A sawmill performing log sawing can be mentioned as an example. Sawmills order logs as a number of pieces to different assortments, which is length dependent. As an example of an order may be mentioned an order for 5.20 m long trunks to top diameter class 22-23 with the number of trunks being 550, for example. Length and diameter measurement of logs is performed at the sawmill, too. Due to a measurement error of a work machine 11 and/or a tree-handling device 12, it is not at all exceptional that the measurement result regarding the number of pieces of trunks turns out to be incorrect at the sawmill; i.e., in other words, based on the order, the sawmill has received only 450 trunks for the dimension class concerned. To take this into account, for example, the sawmill needs to anticipate the situation in such a way that it needs to order, due to a possibly erroneous log measurement of a work machine 11/a tree-handling device 12, either too many or alternatively too few trunks, if the measurement error of the work machine 11/tree-handling device 12 is downwards in the diameter class concerned, so that the order is surely sufficient for the required number of pieces of the tree. The significance of a measurement error in the diameter measurement is excellently reflected in that an error of 1 cm in the length measurement can create an additional cost of several millions, even over 10 millions of euros in a year for the sawmill, particularly in the case of a larger sawmill. In this respect, too, a method according to the invention improves the situation.

It is to be understood that the above description and the related figures are only intended to illustrate the present invention. The invention is therefore not only restricted to the embodiments set forth above or those defined in the claims, but several different variations and adaptations of the invention that are possible within the inventive idea defined by the appended claims will be obvious to a person skilled in the art.

1. A method for a check measurement of a log processed with a tree-handling device, the method comprising:
measuring, through use of a measurement device, a diameter of at least one log processed with the tree-handling device according to a measuring instruction created for the at least one log and determined based on measurement data created in connection with a processing of the at least one log with the tree-handling device;
comparing at least one diameter measured with the measurement device of the at least one log to the diameter determined in connection with the processing of the at least one log with the tree-handling device;
determining based on the comparison, an accuracy of the diameter determined in connection with the processing of the at least one log with the tree-handling device; and
executing a command, wherein said command includes at least one of controlling a diameter determination performed in connection with the processing of the at least one log with the tree-handling device and creating information concerning the performed diameter determination based on the determined measuring accuracy.

2. The method according to claim 1, further comprising:
defining a dedicated measuring instruction for at least part of said at least one log based on the measurement data created in connection with the processing of the at least one log with the tree-handling device; and
arranging one or more measuring points in a longitudinal direction (L) of the at least one log in the measuring instruction for measuring the diameter of the at least one log with the measurement device at the measuring points.

3. The method according to claim 1, wherein, for at least part of said at least one logs, the measuring instruction includes one or more suggested measuring positions, of which at least one measuring point is selected or imposed for a measurement of the at least one log with the measurement device.

4. The method according to claim 1, wherein the measuring instruction includes at least one measuring area in the longitudinal direction (L) of the at least one log, determined based on the measurement data created in connection with the processing of the at least one log with the tree-handling device, where in connection with the measurement of the diameter of the at least one log with the measurement device, the diameter of the at least one log is measured in the at least one measuring areas.

5. The method according to claim 1, wherein when measuring the at least one log with the measurement device, the method further comprises at least one of:
selecting, via a measurer, at least one measuring point on the basis of the measuring instruction;
suggesting at least one measuring point for the measurer based on the measuring instruction;
instructing the measurer to measure at least one measuring point based on the measuring instruction; and
measuring automatically, via the measuring device, in at least one of a measuring area imposed by the measuring instruction, the at least one measuring point imposed by the measuring instruction, and a combination of each.

6. The method according to claim 1, wherein a measuring point is located in the longitudinal direction (L) of the at least one log at a point or in an area where the diameter of the at least one log is mainly constant or changes uniformly by increasing or decreasing.

7. The method according to claim 1, further comprising:
determining in a longitudinal direction (L) of the at least one log at least one point or area including a local deviation in the diameter of the at least one log, where an otherwise constant or uniformly changing diameter of the at least one log both increases and decreases, or vice versa, at a relatively short distance in the longitudinal direction of the at least one log; and
imposing the measuring point outside the at least one point or area.

8. The method according to claim 1, further comprising:
determining in a longitudinal direction (L) of the at least one log at least one area, where the diameter of the at least one log does not change substantially or changes uniformly such that a diameter between the start point and the end point of the at least one area either increases or decreases in the longitudinal direction (L) of the at least one log; and
selecting at least one measuring point from the determined at least one area.

9. The method according to claim 1, further comprising:
determining, through use of the tree-handling device, a cross-sectional shape of the at least one log in a longitudinal direction (L) in connection with the processing of the at least one log; and
creating the measuring instruction for the at least one log based on information concerning the determined cross-sectional shape of the at least one log.

10. The method according to claim 1, wherein the measurement device further facilitates at least one of the following:
receiving at least part of the measuring instructions for measurement of the at least one log;
creating at least part of the measuring instruction for the measurement of the at least one log from the measurement data; and
sending, via a transmitter, a measurement results.

11. The method according to claim 1, wherein the measuring instructions defined based on the measurement data created in connection with the processing of the at least one log with the tree-handling device are used for the at least one log either without a standard measuring points or together with at least part of the standard measuring point.

12. The method according to claim 11, further comprising at least one of the following:
filtering out unreliable measuring points from the standard measuring points based on the measurement data created in connection with the processing of the at least one log with the tree-handling device; and
reducing a weighting of the standard measuring points based on the measurement data created in connection with the processing of the at least one log with the tree-handling device.

13. The method according to claim 1, wherein, when measuring the diameter of the at least one log with the measurement device at a measuring point, the method further comprises:
measuring the diameter of the at least one log in two or more positions in a circumferential direction of the at least one log and storing the diameter of the at least one log corresponding the measured positions; and,
wherein information is created based on the diameter measurement of the at least one log, said information is used according to at least one of:
determining a mean value of the diameter of the at least one log at the measurement point;
defining one or more measuring directions that meet the set criteria for a crosswise measurement performed with the measurement device and performing the crosswise measurement with the measurement device in these defined one or more measuring directions; and
controlling the crosswise measurement based on the determination, where at least one measuring direction is indicated for guiding the measurement to a measurer and an indication is given to the measurer, when the measurement device is found to be in a position corresponding to the defined measuring direction.

14. The method according to claim 13, wherein when measuring the diameter of the at least one log at the measuring point with the measurement device, the diameter of the at least one log is measured in the circumferential direction as a continuous measurement while storing the diameter of the at least one log.

15. The method according to claim 1, wherein the tree-handling device is a harvester head that is arranged in a work machine.

16. The method according to claim 1, wherein measurement results created with the measurement device are used for at least one of:
maintaining an accuracy of a diameter measuring function of at least one of a work machine and the tree-handling device including a calibration measurement and tuning of the diameter measuring function performed based on the calibration measurement;
monitoring of the measuring accuracy of at least one of the work machine and the tree-handling device;
checking measurement of at least one of the work machine and the tree-handling device;
monitoring fault diagnostics of at least one of the work machine and the tree-handling device;
evaluating measurement quality assurance; and
monitoring and adjusting of an operation of at least one of the work machine and the tree-handling device.

17. The method according to claim 1, further comprising:
creating the measurement data based on at least one sensor connected to one or more contact functions of the tree-handling device;
creating and storing status data of the one or more contact functions concerning at least one of a measurement of a lengthwise position and a corresponding diameter measurement, the status data related to a current position of the one or more contact functions relative to the at least one log processed; and
creating the measuring instruction through use of the status data of the one or more contact functions.

18. A measurement system for a check measurement of a log processed with a tree-handling device, which is arranged to be performed with a measurement device for measuring a diameter of the log processed with the tree-handling device at one or more longitudinal (L) measuring points of the log, the measurement system comprising:
the tree-handling device arranged to process the log;
at least one sensor configured to create measurement data in connection with the processing of the log, the measurement data including a lengthwise position and a diameter of the log;
at least one processor and a memory connected to the at least one processor, the at least one processor arranged to compare the diameter of the log based on the measurement data to the diameter of the log measured with the measurement device; and
wherein the at least one processor is configured to:
create a measuring instruction for the log based on the measurement data created in connection with the processing of the log with the tree-handling device;
compare at least one diameter measured with the measurement device to the diameter determined in connection with the processing of the log with the tree-handling device;
determine, based on the comparison, an accuracy of the diameter determined in connection with the processing of the log with the tree-handling device; and
control a diameter determination performed in connection with the processing of the log with the tree-handling device based on the determined accuracy or create information concerning the diameter determination based on the determined accuracy, and the measurement device is configured to measure the diameter of the log processed with the tree-handling device according to the measuring instruction created for the log.

19. (canceled)

20. A forest machine configured to perform one or more steps of the method according to claim 1.

21. (canceled)

22. Hardware comprising at least one memory unit for storing program code and at least one processor configured to execute the program code, wherein in connection with execution the hardware performs one or more steps according to claim 1.

23. The hardware of claim 22, further comprising:
a first interface arranged for data transfer concerning measurement data created in connection with processing of a log with a tree-handling device; and
a second interface arranged for data transfer concerning information that is created in the hardware based on the measurement data created in connection with the processing of the log with the tree-handling device;
wherein, in response to the one or more processors executing the program code, the hardware is configured to:
create a measuring instruction based on the measurement data created in connection with the processing of the log with the tree-handling device as information for the log, which is arranged to be used for a check measurement of a the log processed with the tree-handling device.
